(19) United States
(12) Patent Application Publication
(10) Pub. No.: US 2006/0248552 A1
(43) Pub. Date: Nov. 2, 2006

(54) Optical information storage medium

(75) Inventors: Yuan-Chang Lai, Taipei Hsien (TW); Hon-Lun Chen, Taipei Hsien (TW)

Correspondence Address: BIRCH STEWART KOLASCH & BIRCH, PO BOX 747, FALLS CHURCH, VA, 22040-0747, US

(73) Assignee: PRODISC TECHNOLOGY INC.

(21) Appl. No.: 11/398,560

(22) Filed: Apr. 6, 2006

(30) Foreign Application Priority Data
Apr. 13, 2005 (TW) 094111726

(51) Int. Cl. G11B 7/24; G11B 3/70

(52) U.S. Cl. 720/718; 369/286

(57) ABSTRACT

An optical information storage medium includes a first substrate, a first recording stack layer, a second substrate, and a first hard coating layer. The first recording stack layer is disposed above the first substrate. The second substrate is disposed above the first recording stack layer, and the first hard coating layer is disposed on one surface of the second substrate.

### BACKGROUND OF THE INVENTION

1. Field of Invention

The invention relates to an optical information storage medium and, in particular, to an optical information storage medium, which is not easily deformed.

2. Related Art

Generally, the digital versatile disc (DVD) can be divided into the single side single layer DVD, dual side single layer DVD, single side dual layer DVD, and dual side dual layer DVD.

As shown in FIG. 1, a conventional single side single layer DVD 1, has a first substrate 11, a first recording stack layer 12, and a second substrate 13. In this case, the first recording stack layer 12 includes a first recording layer 121 disposed on the first substrate 11 and a first reflective layer 122 disposed on the first recording layer 121.

Traditionally, the first reflective layer 122 is formed by sputtering or evaporation. The manufacturer often adopts polycarbonate (PC) as the material of the first substrate 11 and the second substrate 13. However, the mechanical property of the first substrate 11 can not stand the high temperature of the sputtering or evaporation process, so that the outcome disc may be deformed.

For manufacturing a single side dual layer DVD, the manufacture processes are divided into two different kinds. One is the photo-polymerization process (2P process), and the other is the bonding process (also called a revered process) During both of these two manufacture processes, the above mentioned problem of disc deformation caused by sputtering or evaporation happens. Besides, in the photo-polymerization process, when the disc stamper is peeled off, the mechanical property of the first substrate 11 sometimes is not strong enough to stand the stress, which results in the disc bending.

As described above, it is an important subject to provide an optical information storage medium to solve the above-mentioned problems.

### SUMMARY OF THE INVENTION

In view of the foregoing, the invention is to provide an optical information storage medium, which can improve the easy deformation problem and the scratch problem of the substrate so as to increase the production yield of the optical information storage medium.

To achieve the above, an optical information storage medium of the invention includes a first substrate, a first recording stack layer, a second substrate, and a first hard coating layer. The first recording stack layer is disposed above the first substrate. The second substrate is disposed above the first recording stack layer, and the first hard coating layer is disposed on one surface of the second substrate.

As mentioned above, the optical information storage medium of the invention includes a first hard coating layer disposed on the surface of the second substrate. By this way, the second substrate is strengthened, and not easily deformed. The problem of easy bending, deformation, or scratch of the first substrate is inhibited. As a result, the optical information storage medium has advantages of improving production yield and thus lowering the production cost.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional optical information storage medium;

FIG. 2 is a schematic view of an optical information storage medium according to a first embodiment of the invention;

FIG. 3 is a schematic view of an optical information storage medium according to a second embodiment of the invention; and

FIG. 4 is a schematic view of an optical information storage medium according to a third embodiment of the invention.

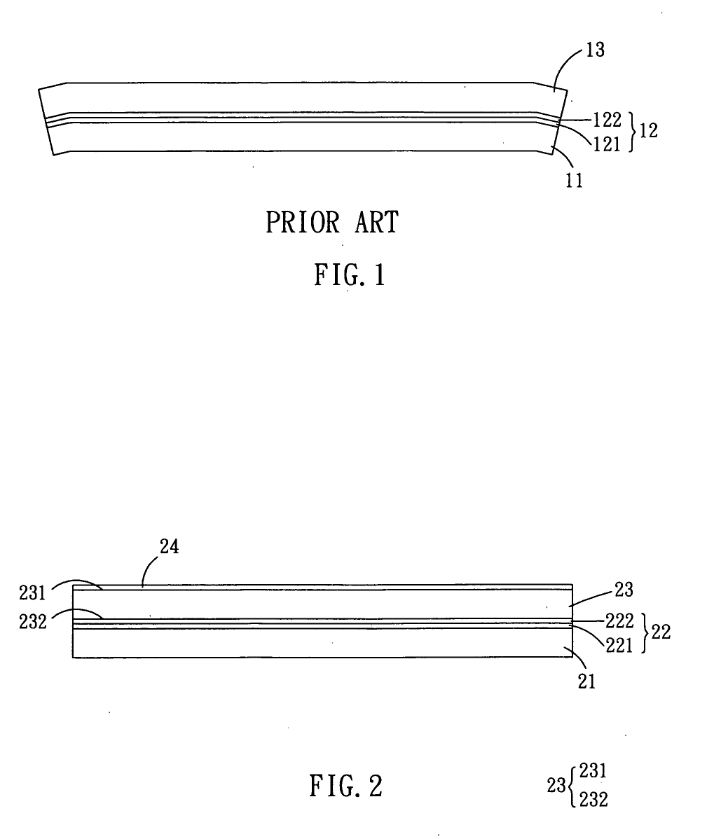

### DETAILED DESCRIPTION OF THE INVENTION

The optical information storage medium according to embodiments of the invention will be described herein below with reference to the accompanying drawings, wherein the same reference numbers refer to the same elements.

FIG. 2 is a schematic view of an optical information storage medium according to a first embodiment of the invention. Referring to FIG. 2, an optical information storage medium 2 includes a first substrate 21, a first recording stack layer 22, a second substrate 23 and a hard coating layer 24. In the embodiment, the optical information storage medium 2 is a single side single layer disc for example.

The first substrate 21 is usually made of polycarbonate (PC).

The first recording stack layer 22 is disposed above the first substrate 21. The first recording stack layer 22 includes a first recording layer 221 and a first reflective layer 222. In this case, the first recording layer 221 is formed on the first substrate by spin coating and the first reflective layer 222 is formed on the first recording layer 221 by sputtering or evaporation.

The second substrate 23 is usually made of polycarbonate (PC). The second substrate 23 has a upper surface 231 and a lower surface 232, and the second substrate 23 is disposed above the first recording stack layer 22.

The first hard coating layer 24, in the embodiment, is made of silicon dioxide, which is one of dielectric materials. The first hard coating layer 24 is formed on the upper surface 231 of the second substrate 23 by sputtering. Furthermore, the material of the first hard coating layer 24 can be silicon carbide, silicon nitride, or zinc sulfide-silicon dioxide, and it may be formed on the upper surface 231 of the second substrate 23 by sputtering or evaporation. As a result, the first hard coating layer 24 is disposed on the surface of the second substrate 23 opposite to the first recording stack layer 22. Besides, the material of the first hard coating layer 24 can be a lacquer, which is at least one selected from the group consisting of UV cured lacquer and thermal cured lacquer. The first hard coating layer 24 is formed on the upper surface 231 of the second substrate 23 by spin coating. The ways of forming the first hard coating layer 24 on the second substrate 23 are diverse, and they may include sputtering, evaporation, and spin coating. Moreover, the first hard coating layer 24 can be formed on the upper surface 231 of the second substrate 23 by adhesion.

Owing to the poor mechanical property, the first substrate 21 is easily deformed and bent during the sputtering or evaporation process, and the user may scratch the surface of the first substrate 21. In the embodiment, since the hard coating layer 24 is provided on the upper surface 231 of the second substrate 23, the flatness of the optical information storage medium can still be obtained by bonding the bent or deformed first substrate 21 to the second substrate 23. Besides, forming the first hard coating layer 24 to protect the first substrate 21 can prevent the users to scratch the substrate surface.

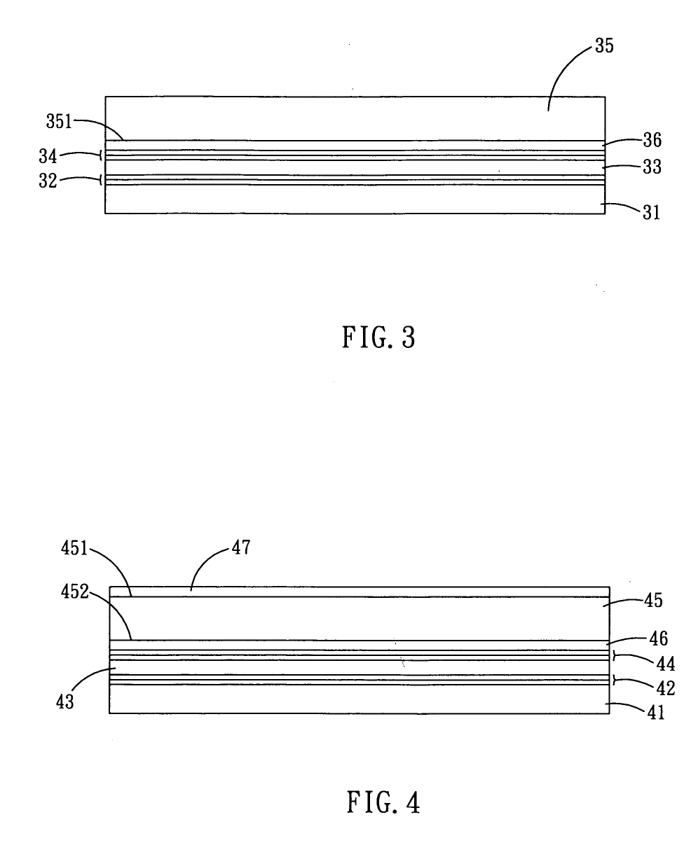

In addition to the single side single layer disc, the invention also can be applied to other kinds of DVDs. FIG. 3 is a schematic view of a second embodiment of the optical information storage medium of the invention. In this embodiment, the optical information storage medium 3 is a single side dual layer disc formed by the bonding process. The optical information storage medium 3 includes a first substrate 31, a first recording stack layer 32, a second substrate 35 and a first hard coating layer 36. The first recording stack layer 32 is disposed on the first substrate 31. The second substrate 35 is disposed above the first recording stack layer 32, and the second substrate 35 has a lower surface 351. The first hard coating layer 36 is disposed on the lower surface 351 of the second substrate 35. As a result, the first hard coating layer 36 is disposed between the second substrate 35 and the first recording stack layer 32. Besides, the optical information storage medium 3 of the embodiment further includes a spacer layer 33 and a second recording stack layer 34. The spacer layer 33 is disposed on the first recording stack layer 32, and the second recording stack layer 34 is disposed on the spacer layer 33. The manufacture processes and steps are not the features of the invention, so the detailed descriptions are omitted for concise purpose.

The first hard coating layer 36 is disposed on the lower surface 351 of the second substrate 35, so that, as a result, even after the sputtering or evaporation process, the second substrate 35 can still keep its original shape and is not deformed. If the first substrate 31 is bent or deformed after the sputtering process, the flatness of the optical information storage medium 3 can still be obtained by bonding the first substrate 31 to the second substrate 35.

FIG. 4 is a schematic view of a third embodiment of the optical information storage medium of the invention. In this embodiment, the optical information storage medium is a single side dual layer disc and is formed by the photo-polymerization process. The optical information storage medium 4 includes a first substrate 41, a first recording stack layer disposed on the first substrate 41, a second substrate 45 disposed above the first recording stack layer 42, and a first hard coating layer 46 disposed on the lower surface of the second substrate 45. Besides, the optical information storage medium 4 further includes a spacer layer 43 disposed on the first recording stack layer 43 and the second recording stack layer 44. The photo-polymerization manufacture process is not the feature of the invention, so the detailed descriptions are omitted for concise purpose. The difference between the third embodiment and second embodiment is that the optical information storage medium 4 further includes a second hard coating layer 47, which is disposed on the upper surface 451 of the second substrate 45. The first hard coating layer 46 is disposed on the lower surface 452 of the second substrate 45, and the second hard coating layer 47 is disposed on the upper surface 451 of the second substrate 45. As a result, the mechanical property of the second substrate 45 has been further enhanced, and the scratches on the second substrate 45 are prevented. Meanwhile, the second substrate 45 not only can stand the high temperature of the sputtering or evaporation process, but also can endure the stress of the peeling off step and keep the optical information storage medium 4 in the flat shape.

It is clear that the first hard coating layer can be disposed on one surface of the second substrate. The first hard coating layer and the second hard coating layer can be disposed on two opposite surfaces of the second substrate respectively. These embodiments are all in the scope of the invention.

In summary, the optical information storage medium of the invention includes a first hard coating layer disposed on the surface of the second substrate. By this way, the second substrate is strengthened, and not easily deformed. Furthermore, the bent first substrate can be recovered to the flat structure by bonding it to the second substrate with the first hard coating layer. As a result, the optical information storage medium has advantages of improving production yield and thus increasing its production quality.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical information storage medium, comprising:
a first substrate;
a first recording stack layer, which is disposed above the first substrate;
a second substrate, which is disposed above the first recording stack layer; and
a first hard coating layer, which is disposed on one surface of the second substrate.

2. The optical information storage medium of claim 1, wherein the first hard coating layer is made of a dielectric material.

3. The optical information storage medium of claim 2, wherein the dielectric material is disposed by sputtering to form the first hard coating layer.

4. The optical information storage medium of claim 2, wherein the dielectric material is at least one selected from the group consisting of silicon dioxide, silicon carbide, silicon nitride and zinc sulfide-silicon dioxide.

5. The optical information storage medium of claim 1, wherein the first hard coating layer is lacquer.

6. The optical information storage medium of claim 5, wherein the lacquer is applied to the first second substrate by spin coating to form the first hard coating layer.

7. The optical information storage medium of claim 5, wherein the material of the lacquer is at least one selected from the group consisting of UV cured lacquer and thermal cured lacquer.

8. The optical information storage medium of claim 1, wherein the first hard coating layer is disposed on the surface of the second substrate by adhesion.

9. The optical information storage medium of claim 1, wherein the first hard coating layer is disposed between the second substrate and the first recording stack layer.

10. The optical information storage medium of claim 1, wherein the first hard coating layer is disposed on the surface of the second substrate opposite to the first recording stack layer.

11. The optical information storage medium of claim 1, further comprising:
a second recording layer, which is positioned between the first recording stack layer and the second substrate.

12. The optical information storage medium of claim 1, wherein the second substrate further includes a second hard coating layer, and the second hard coating layer is disposed on another surface of the second substrate opposite to the surface disposed with the first hard coating layer.

13. The optical information storage medium of claim 12, wherein the second hard coating layer is made of a dielectric material.

14. The optical information storage medium of claim 13, wherein the dielectric material is disposed on the second substrate by sputtering to form the second hard coating layer.

15. The optical information storage medium of claim 13, wherein the dielectric material is at least one selected from the group consisting of silicon dioxide, silicon carbide, silicon nitride and zinc sulfide-silicon dioxide.

16. The optical information storage medium of claim 12, wherein the second hard coating layer is lacquer.

17. The optical information storage medium of claim 16, wherein the lacquer is applied to the second substrate by spin coating to form the second hard coating layer.

18. The optical information storage medium of claim 16, wherein the material of the lacquer is at least one selected from the group consisting of UV cured lacquer and thermal cured lacquer.

19. The optical information storage medium of claim 1, wherein the second hard coating layer is disposed on the second substrate by adhesion.
